(19) United States
(12) Patent Application Publication
(10) Pub. No.: US 2026/0283117 A1
(43) Pub. Date: Sep. 24, 2026

(54) Pet Leash Cam-Adjust Mechanism and Leash Assembly Incorporating Same

(71) Applicant: Paul Vizzio, New York, NY (US)

(72) Inventor: Paul Vizzio, New York, NY (US)

(21) Appl. No.: 19/355,611

(22) Filed: Oct. 10, 2025

Related U.S. Application Data
(60) Provisional application No. 63/730,568, filed on Dec. 11, 2024.

(51) Int. Cl. A01K 27/00

(52) U.S. Cl. CPC A01K 27/003

(57) ABSTRACT

A cam-adjust mechanism for a pet leash includes a main body through which a strap extends, a pivoting cam mounted on a shaft, and a torsion spring biasing the cam toward a locked position. Depressing the cam releases tension to permit length adjustment, after which the spring returns the cam to a locked state. The mechanism may connect to a side-release buckle and include a loop for accessories such as a bag holder. An alternative embodiment integrates the buckle into the housing and adds a used bag holder.

### CROSS REFERENCE TO RELATED APPLICATIONS

This application claims the benefit of U.S. Provisional Application No. 63/730,568, filed on Dec. 11, 2024, titled “Pet Leash Adjustment and Attachment Mechanism,” the entire contents of which are incorporated herein by reference.

### FIELD OF THE INVENTION

The present invention relates to pet leashes and strap-based retention devices, and more particularly to a cam-adjust mechanism that permits rapid, one-handed adjustment of a leash loop while maintaining a secure locking engagement.

### BACKGROUND

Conventional leashes connect a pet to a handler using a flexible tensile member such as a webbing strap or rope. Many modern leashes include additional features such as hands-free waist loops or clips for attaching to fixed objects. However, existing adjustment mechanisms typically rely on slide buckles, double-D rings, or ladder locks that require two hands and considerable effort to set or release.

Such hardware is designed for semi-permanent length settings and not for frequent on-the-fly adjustment. When a user wishes to convert from a hand-held configuration to a waist loop or to quickly clip around a post, existing mechanisms are slow and awkward to operate.

There therefore exists a need for a compact, single-hand operable mechanism that allows a leash loop to be adjusted smoothly and securely, while optionally integrating common accessories such as a bag-holder loop or quick-connect buckle.

### SUMMARY OF THE INVENTION

The present invention provides a cam-adjust mechanism for controlling the effective length of a flexible leash or strap. A pivoting cam element is mounted to a main body on a shaft and is biased by a torsion spring toward a locked position. The cam defines a curved friction surface that engages the leash when the cam is rotated under spring force, thereby preventing motion of the strap. Depressing the cam against the spring bias lifts the friction surface away and permits the leash to slide freely for adjustment.

The mechanism is configured to connect to a standard side-release buckle via a short length of webbing so that a user can quickly open or separate the loop without threading the entire leash through the device. Alternative embodiments may integrate the buckle directly into the housing.

A loop feature may be molded or attached to the housing for mounting accessories such as a poop-bag holder, light, or identification tag. An earlier embodiment may further include a hook feature for temporary retention of used bags.

The cam-adjust mechanism provides fast, repeatable length adjustment using only one hand, reduces bulk and weight relative to buckled systems, and maintains high tensile strength through the strap path. While described for pet leashes, the mechanism is also applicable to other strap-based devices such as belts, harnesses, or luggage.

### BRIEF DESCRIPTION OF DRAWINGS

The accompanying drawings illustrate example embodiments of the invention. Like reference numerals refer to corresponding parts throughout the views. The drawings are not necessarily to scale.

FIG. 1 is an isometric view of the cam-adjust mechanism assembled with the leash loop attached, illustrating the hand-held configuration.

FIG. 2 is an isometric view of the cam-adjust mechanism with the leash handle loop unclipped from the buckle, showing how the leash end may be wrapped around a user's waist, a post, or another fixed object before re-attaching.

FIG. 3 is a side view of the cam-adjust mechanism with the loop detached, showing the overall housing profile, strap path, and relative position of the cam lever and buckle connection.

FIG. 4 is a cross-sectional view of the cam mechanism in a locked position in which the cam surface engages the strap to prevent movement.

FIG. 5 is a cross-sectional view of the cam mechanism in a released position permitting the strap to slide through the housing for adjustment.

FIG. 6 is an exploded view illustrating the internal components of the cam-adjust mechanism, including the pivot shaft and torsion spring that bias the cam toward the locked position.

FIG. 7 is a detailed cross-sectional view of the cam mechanism alone, shown in a released position with the lever rotated away from the housing and free of strap engagement.

FIG. 8 is a detailed cross-sectional view of the cam mechanism alone, shown in the locked position with the lever fully butted against an interior face of the housing under torsion-spring bias.

FIG. 9 is a side view of a leash assembly using the cam-adjust mechanism configured as a large loop suitable for waist attachment.

FIG. 10 is an isometric view of an alternative embodiment in which the buckle is integrated into the housing and a used-bag hook is provided on the exterior surface.

FIG. 11 is a cross-sectional view of the integrated-buckle embodiment of FIG. 10 showing the internal cam and strap path.

### A DETAILED DESCRIPTION

Details of several embodiments of the present invention are described below with reference to the accompanying drawings. While the embodiments are described in the context of a pet leash, the described mechanism may be used in any application requiring a compact, quickly adjustable strap control device.

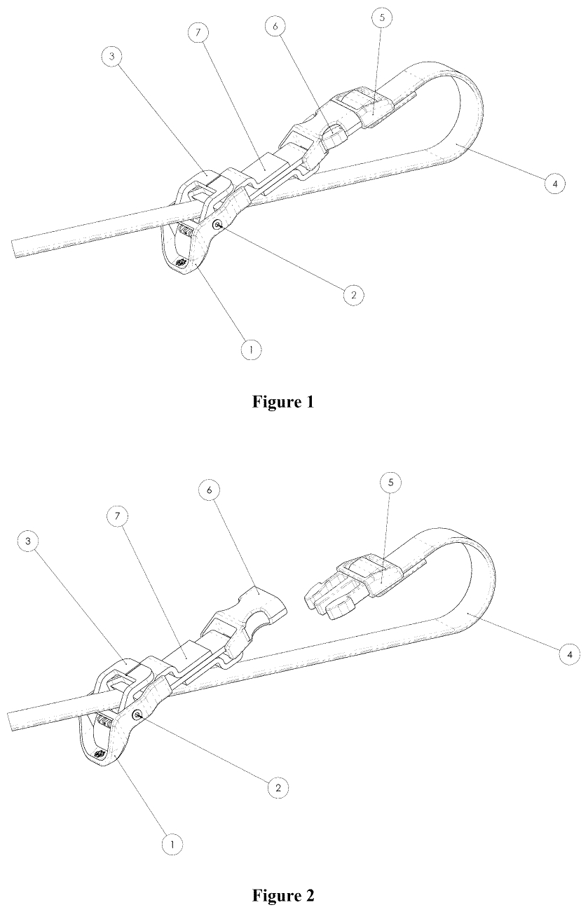

Referring to FIGS. 1-3 and 6, a flexible leash strap (4) extends through a cam-adjust mechanism comprising a main body (1), a pivot shaft (2), a cam lever (3), and a torsion spring (8). The spring (8) biases the cam lever (3) toward a locked position. The strap (4) enters and exits the housing through a defined strap path that passes beneath the cam lever (3). A short connecting webbing segment (7) links the main body (1) to one half of a side-release buckle (6). The mating buckle half (5) is attached to the opposite end of the leash, allowing the user loop to be opened or closed without re-threading the strap through the cam mechanism.

In the configuration of FIG. 1, the leash forms a hand-sized loop suitable for normal walking. When tension is applied to the strap (4), the strap bears against an internal face (10) of the main body (1) and the strap-contacting face (11) of the cam lever (3). The torsion spring (8) holds the cam lever (3) in the locked position so that the strap cannot slip.

FIG. 2 illustrates how the buckle halves (5) and (6) can be separated to open the loop. This allows the leash to be wrapped around the user's waist, a post, bench leg, or other object that cannot be passed through the closed loop. After wrapping, the buckle halves are re-attached, re-forming the loop without altering the strap path through the mechanism.

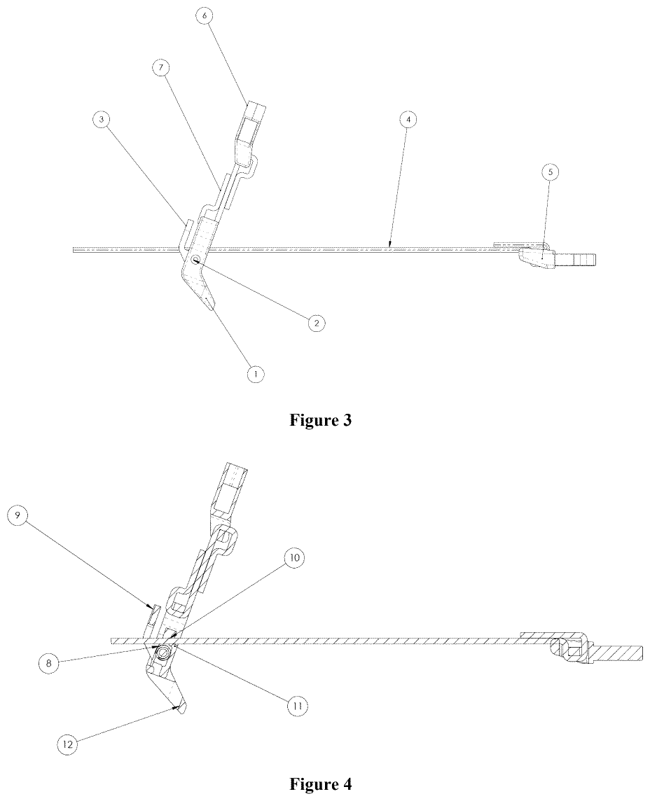

FIG. 3 provides a side view of the cam-adjust mechanism with the loop detached, showing the compact overall geometry and relative positions of the cam lever (3), pivot shaft (2), and buckle interface (6, 7).

Referring to FIG. 4, a cross-sectional view of the mechanism in its locked position is shown. The torsion spring (8) urges the cam lever (3) such that its strap-contacting face (11) presses the strap (4) firmly against the internal body face (10). This clamping action prevents motion of the strap. The external face (12) of the loop portion of the housing provides an attachment surface for accessories such as a poop-bag holder. The lever's outer top face (9) may include texturing or a raised grip area to assist operation with one hand.

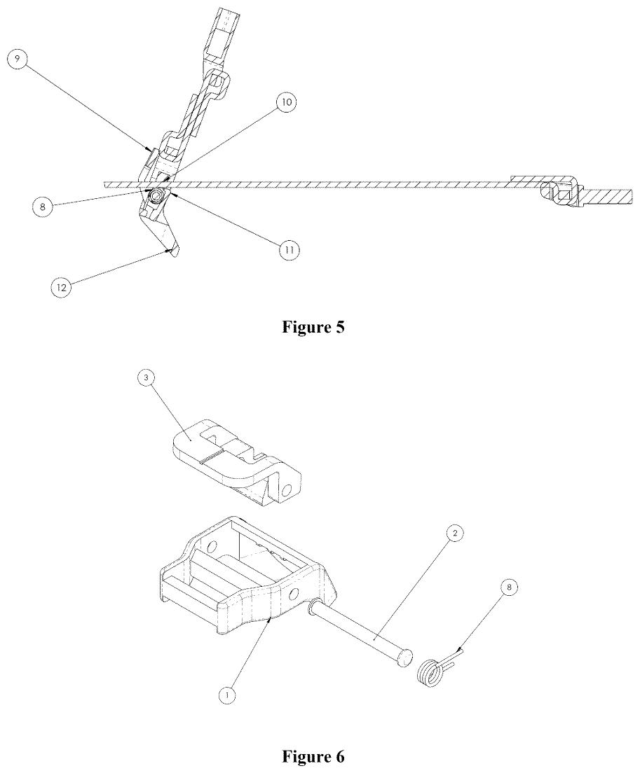

FIG. 5 depicts the same cross-section in the released position. Here, the user depresses the top face (9) of the cam lever (3), rotating the lever (3) about the pivot shaft (2) against the torsion spring (8). The gap (13) between the strap-contacting face (11) and the internal body face (10) increases, allowing the strap (4) to slide freely for adjustment. Releasing the lever (3) allows the spring to return the lever (3) to the locked position automatically.

Referring to FIG. 6, an exploded view shows the internal assembly. The pivot shaft (2) supports the cam lever (3), and the torsion spring (8) is disposed around the shaft with one leg bearing against the lever (3) and the opposite leg anchored to the main body (1). The short webbing segment (7) attaches to the body through an opening near the buckle half (6). The strap (4) passes continuously through the body, forming the adjustable loop controlled by the lever (3). The compact component arrangement provides a durable yet lightweight construction.

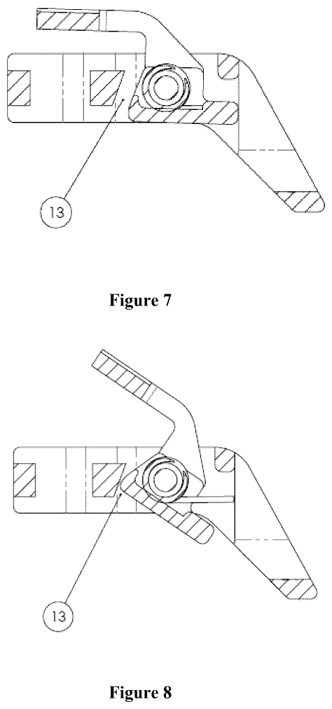

FIGS. 7 and 8 illustrate the cam mechanism in isolation, without the strap or buckle components. In FIG. 7, the lever (3) is shown in the released position, rotated away from the body so that the gap (13) between faces (10) and (11) is open. In FIG. 8, the lever (3) has returned under spring bias to the locked position, where the lever's rear surface butts against an interior stop face of the body, closing the gap (13) and providing full clamping engagement. This demonstrates the range of lever travel and the spring-biased operation that alternates between the two states.

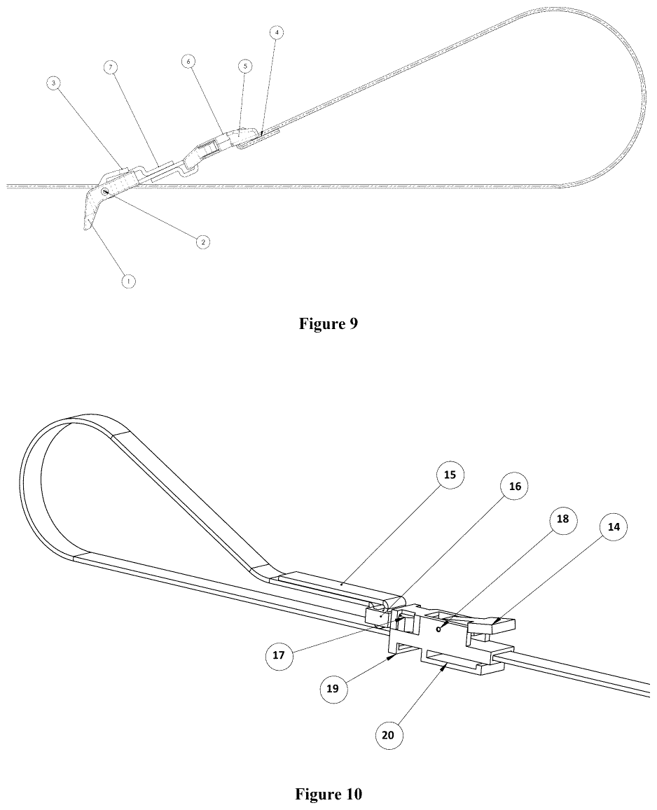

FIG. 9 shows the leash configured as a large waist loop. In this configuration, the cam-adjust mechanism (1-3, 8) securely holds the strap (4) at the desired length under load while allowing quick re-adjustment by depressing the cam lever (3) to release the strap.

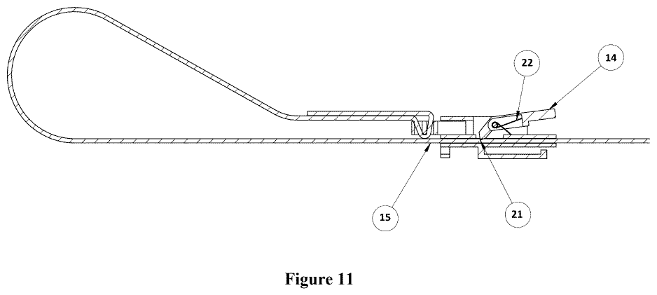

FIGS. 10 and 11 illustrate an alternative embodiment representing the earlier integrated-buckle design. In this version, a cam lever (14) pivots on a shaft (18) within a main housing (17) that is integral with a side-action buckle (16). A poop-bag holder loop (19) and a used-bag hook (20) extend from the exterior of the housing. The leash strap (15) passes through the mechanism and is clamped by the sharp end (21) of the lever (14) against the interior body surface when locked. A torsion spring (22) biases the lever toward the locked position. The cross-section of FIG. 11 shows the internal relationship between these components. This integrated configuration reduces separate parts but functions according to the same cam-locking principle as the main embodiment.

The components described above may be molded or machined from durable materials such as glass-filled nylon, acetal, aluminum, or stainless steel. The strap-contacting faces (10) and (11) may incorporate molded texture, over-molded elastomer, or surface treatments to increase friction. The pivot shaft (2) or (18) may be metallic or polymeric, secured by press-fit or fasteners. The torsion springs (8) and (22) may be formed from stainless steel or music wire chosen to provide sufficient locking force and return torque.

While specific structures have been illustrated and described, variations may be made without departing from the spirit and scope of the invention. For example, the spring type may be changed, additional guides or rollers may be included in the strap path, or the mechanism may be adapted for different strap widths or non-leash applications such as belts, harnesses, or cargo restraints. It is intended that all such variations and equivalents are encompassed within the scope of the appended claims.

What is claimed is:

1. A cam-adjust mechanism for a leash comprising:
a main body defining a strap path through which a flexible leash extends;
a cam element pivotably mounted to the main body about a shaft;
and a torsion spring biasing the cam element toward a locked position wherein a cam surface frictionally engages the leash to prevent movement, whereby manual rotation of the cam against the spring bias permits adjustment of the leash length.

2. The mechanism of claim 1 wherein the strap path includes a curved bearing surface configured to direct tension from the leash toward the cam surface to enhance locking.

3. The mechanism of claim 1 wherein the cam element is formed of rigid polymer or metal and includes a high-friction insert along the cam surface.

4. The mechanism of claim 1 further comprising a loop feature integral with the main body for mounting a bag holder or accessory.

5. The mechanism of claim 1 further comprising a buckle connection secured to the main body by a short segment of webbing.

6. The mechanism of claim 5 wherein the buckle is a side-release buckle adapted to open the user loop of the leash.

7. A leash assembly comprising:
a flexible strap defining a loop portion;
and the cam-adjust mechanism of claim I attached to the loop portion to control its effective length.

8. The leash assembly of claim 7 wherein the cam-adjust mechanism is integrally formed with a buckle housing.

9. The leash assembly of claim 7 wherein the cam-adjust mechanism includes an accessory loop for attaching a bag bolder.

10. A method of adjusting a leash length comprising:
providing a leash having a cam-adjust mechanism according to claim 1;
depressing the cam to release frictional engagement with the leash;
and sliding the leash through the mechanism to achieve a desired loop size, and releasing the cam to lock the leash in position.
